(19) United States
(12) Patent Application Publication
(10) Pub. No.: US 2016/0125662 A1
(43) Pub. Date: May 5, 2016

(54) RIDE-SHARE FARE CALCULATION DEVICE AND METHOD

(71) Applicant: FUJITSU LIMITED, Kawasaki-shi (JP)

(72) Inventors: Takushi Fujita, Chigasaki (JP); Takuro Ikeda, Yokohama (JP); Eiji Kitagawa, Singapore (SG); Taizo ANAN, Kawasaki (JP)

(21) Appl. No.: 14/867,095

(22) Filed: Sep. 28, 2015

(30) Foreign Application Priority Data
Oct. 31, 2014 (JP) 2014-223364

(51) Int. Cl. G07B 13/02

(52) U.S. Cl. CPC G07B 13/02

(57) ABSTRACT

When plural users, including users with different disembarkation points, are using, by ride-sharing, a vehicle of a passenger transportation service that determines a fare according to at least one of usage distance or usage time, a payment amount of a passenger disembarking at a disembarkation point at which a user disembarks is calculated, based on a number of disembarking passengers at the disembarkation point, a number of passengers before disembarkation at the disembarkation point, a balance of the fare to the disembarkation point minus a paid or collected payment amount, and a compensation rate for a subsequently disembarking user.

### CROSS-REFERENCE TO RELATED APPLICATION

This application is based upon and claims the benefit of priority of the prior Japanese Patent Application No. 2014-223364, filed on Oct. 31, 2014, the entire contents of which are incorporated herein by reference.

### FIELD

The embodiments discussed herein are related to a ride-share fare calculation device and method.

### BACKGROUND

Passenger transportation services such as taxis have been used, in which fares are settled by at least one of usage distance and usage time. There are cases in which plural users having different disembarkation points use these passenger transportation services by riding together in a vehicle and, therefore, techniques are known for calculating the fares to be paid by respective users sharing a ride (ride-share).

For example, a first technique has been proposed whereby fares that are generated for each section traveled by each user are equally shared between the users for that section. Further, a second technique has been proposed whereby, for example, a compensation rate for disadvantages in terms of time or the like experienced by a subsequent user to disembark, due, for example, to detours via the disembarkation point of a previous user to disembark, is added to the amount to be paid by the previous user to disembark.

### Related Patent Documents

Japanese Laid-Open Patent Publication No. 2004-213223

Japanese Laid-Open Patent Publication No. 2013-214167

### SUMMARY

According to an aspect of the embodiments, a non-transitory recording medium stores a program that causes a computer to execute a ride-share fare calculation process, the process including: when plural users, including users with different disembarkation points, are using, by ride-sharing, a vehicle of a passenger transportation service that determines a fare according to at least one of usage distance or usage time, calculating a payment amount of a passenger disembarking at a disembarkation point at which a user disembarks, based on a number of disembarking passengers at the disembarkation point, a number of passengers before disembarkation at the disembarkation point, a balance of the fare to the disembarkation point minus a paid or collected payment amount, and a compensation rate for a subsequently disembarking user.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view for explaining a specific example of a taxi fare.

FIG. 2 is a view illustrating one example of the schematic configuration of a ride-share fare calculation device according to the present embodiment.

FIG. 3 is an explanatory view for explaining one example of a fare calculation program that is executed by a computer functioning as a ride-share fare calculation device according to the present embodiment.

FIG. 4 is a block diagram illustrating one example of the schematic configuration of a computer functioning as a ride-share fare calculation device according to the present embodiment.

FIG. 5 is a flowchart illustrating one example of ride-share fare calculation processing executed by a ride-share fare calculation device according to the present embodiment.

FIG. 6 is an explanatory view for explaining ride-share fare calculation processing according to the present embodiment at point i.

FIG. 7 is an explanatory view for explaining a specific example of the respective embarkation and disembarkation points of five users, and the fare meter reading sᵢ at the disembarkation points, in Example 1.

FIG. 8 is an explanatory view for explaining payment amount at the time of disembarkation pᵢ, which is the ride-share fare for each user, in Example 1.

FIG. 9 is an explanatory view for explaining a specific example of the respective embarkation and disembarkation points of five users, and the fare meter reading sᵢ at the disembarkation points, in Example 2.

FIG. 10 is an explanatory view for explaining payment amount at the time of disembarkation pᵢ, which is the ride-share fare for each user, in Example 2.

### DESCRIPTION OF EMBODIMENTS

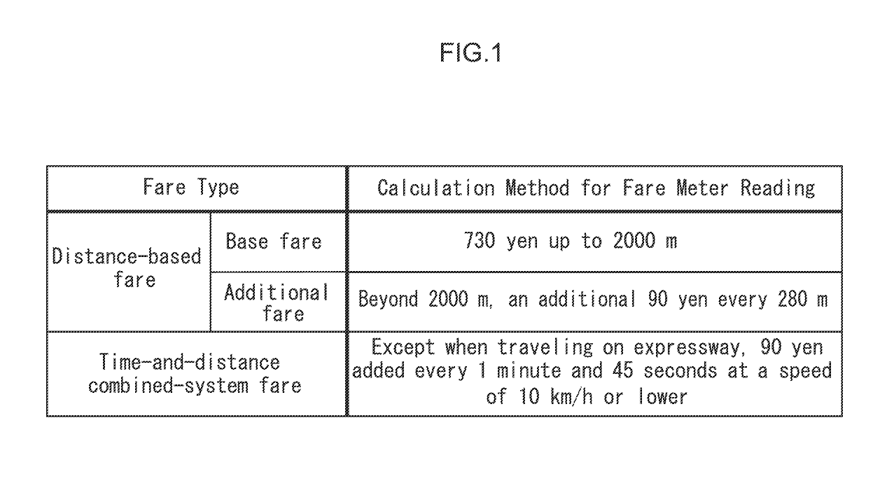

In the following, one embodiment of the disclosed technique is explained in detail with reference to the drawings. In the present embodiment, while a case of using a taxi is explained as one example of a passenger transportation service, it might want to go without saying that the invention is not limited to taxis. As in the specific example illustrated in FIG. 1, a taxi is a passenger transportation service that provides passenger transportation by chartering single vehicles at a measured rate fare based on at least one of usage distance or usage time. Under the calculation method for the fare meter reading sᵢ of the taxi illustrated in FIG. 1, first, as a base fare, there is a uniform fare of 730 yen up to 2000 m. Further, beyond 2000 m, a distance-based fare is applied, whereby a fare of 90 yen is added every 280 m. In addition, other than when traveling on an expressway, a time-and-distance combined-system fare is applied, whereby a fare of 90 yen is added every 1 minute and 45 seconds at a speed of 10 km/h or lower.

In the present embodiment, “ride-share fare” indicates the amount of money to be paid (payment amount) by each of plural users sharing a ride in a taxi.

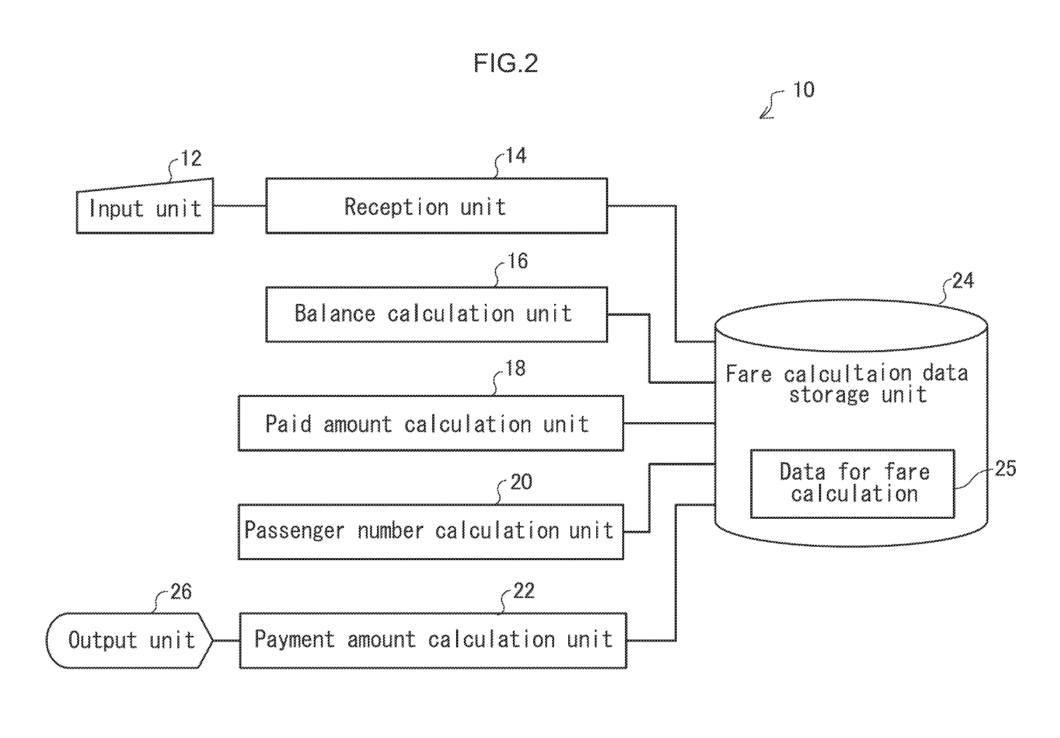

FIG. 2 is a function block diagram illustrating one example of the functional schematic configuration of a ride-share fare calculation device according to the present embodiment. As illustrated in FIG. 2, ride-share fare calculation device 10 is provided with input unit 12, reception unit 14, balance calculation unit 16, paid amount calculation unit 18, passenger number calculation unit 20, payment amount calculation unit 22, fare calculation data storage unit 24, and output unit 26.

Input unit 12 has a function for a user to input data for fare calculation, in order to have ride-share fare calculation device 10 calculate the ride-share fare. In ride-share fare calculation device 10 of the present embodiment, the data for fare calculation that is input by a user is number of embarking passengers bᵢ, number of disembarking passengers dᵢ and fare meter reading sᵢ (details discussed below).

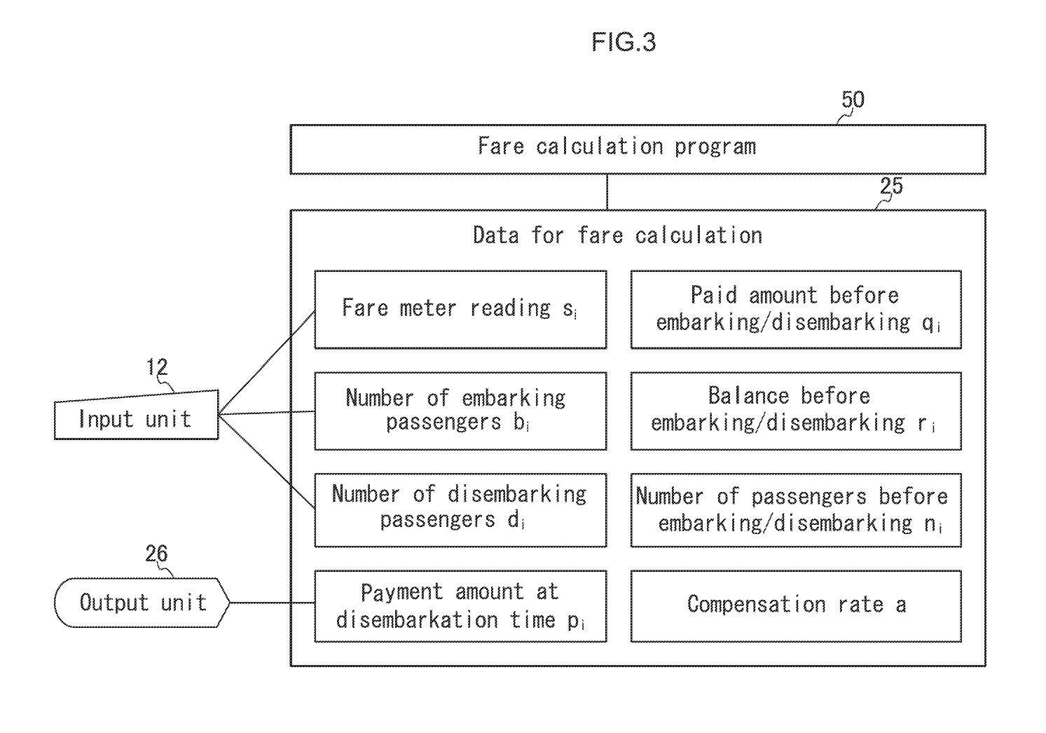

Explanation is provided regarding data for fare calculation 25, which are stored in fare calculation data storage unit 24 of ride-share fare calculation device 10 of the present embodiment. As illustrated in FIG. 3, the data for fare calculation includes fare meter reading sᵢ, number of embarking passengers bᵢ, number of disembarking passengers dᵢ, payment amount at disembarkation time pᵢ, paid amount before embarking/disembarking qᵢ, balance before embarking/disembarking rᵢ, number of passengers before embarking/disembarking and compensation rate a.

“i” is a natural number including 0 and indicates a point number of a point that is an embarking/disembarking location and, at the ride-share starting point or at the first embarkation point, i=0. The fare meter reading sᵢ is the value indicated on the taxi fare meter. The number of embarking passengers bᵢ is the number of users, at point i, getting into a taxi performing ride-share at point i. In the disclosed technique, the number of disembarking passengers dᵢ, which is one example of the number of disembarking passengers at a disembarkation point at which a user or users disembark, is, at point i, the number of users that disembark from a taxi performing ride-share at point i. In the disclosed technique, the payment amount at disembarkation time pᵢ, which is one example of the payment amount for users disembarking at a disembarkation point, is the amount of money to be paid by a user disembarking at point i, and is the ride-share fee. The paid amount before embarking/disembarking qᵢ is the total amount of paid amounts that have already been paid by users that have previously disembarked (or of amounts of money collected from users that have previously disembarked). In the disclosed technique, the balance before embarking/disembarking rᵢ, which is one example of the balance obtained by subtracting paid amounts of money from the fare to a disembarkation point, is the amount of money that has not yet been paid out of the taxi fare to point i (which corresponds to the fare meter reading sᵢ at point i). In the disclosed technique, the number of passengers before embarking/disembarking which is one example of the number of passengers before disembarkation at a disembarkation point, is, at point i, the number of passengers before users embark or disembark; that is, the number of passengers in the taxi immediately before point i.

In the disclosed technique, the compensation rate a, which is one example of a compensation rate with respect to users that disembark subsequently, is for a previously disembarking user to compensate for disadvantages in terms of time or the like experienced by a user that disembarks subsequently, due, for example, to detours for the previous user. In ride-share fare calculation device 10 of the present embodiment, the compensation rate a is a predetermined constant, where 0<compensation rate a<1. While the manner of determining the compensation rate a is not particularly limited, it is preferable that the ride-share fare for each user is a value less than the fare in a case in which an individual used the taxi. In ride-share fare calculation device 10 of the present embodiment, the compensation rate a is empirically determined in advance based on the number of passengers, the number of disembarking passengers, the ride distance and the like, and is stored in ride-share fare calculation device 10. Instead of determining the compensation rate a in advance, it may be made possible for a user to set the compensation rate a. Further, the compensation rate a may be a value that corresponds to circumstance. For example, the compensation rate may be increased in a case in which it is adjudged that significant disadvantage will be experienced by subsequently disembarking passengers due to long detour distances or the like, and the compensation rate may be decreased in a case in which it is adjudged that minimal disadvantage will be experienced by subsequently disembarking passengers due to short detour distances or the like.

Reception unit 14 has the function of receiving number of embarking passengers bᵢ, number of disembarking passengers dᵢ and fare meter reading sᵢ, which are input by a user at input unit 12. The received number of embarking passengers bᵢ, number of disembarking passengers dᵢ and fare meter reading sᵢ are stored at fare calculation data storage unit 24 as data for fare calculation 25.

Fare calculation data storage unit 24 has the function of storing data for fare calculation 25.

Balance calculation unit 16 has the function of calculating balance before embarking/disembarking rᵢ. Balance before embarking/disembarking rᵢ is an amount of money obtained by subtracting, from taxi fare meter reading paid amount before embarking/disembarking qᵢ (fare meter reading sᵢ—paid amount before embarking/disembarking qᵢ).

Paid amount calculation unit 18 has the function of calculating paid amount before embarking/disembarking qᵢ.

Passenger number calculation unit 20 has the function of calculating number of passengers before embarking/disembarking

Payment amount calculation unit 22, which is one example of a calculation unit in the disclosed technique, has the function of calculating payment amount at disembarkation time pᵢ. Payment amount calculation unit 22 in the present embodiment calculates payment amount at disembarkation time pᵢ based on balance before embarking/disembarking rᵢ, number of passengers before embarking/disembarking number of disembarking passengers dᵢ and compensation rate a.

Output unit 26 has the function of outputting, to users, the payment amount at disembarkation time pᵢ calculated by payment amount calculation unit 22.

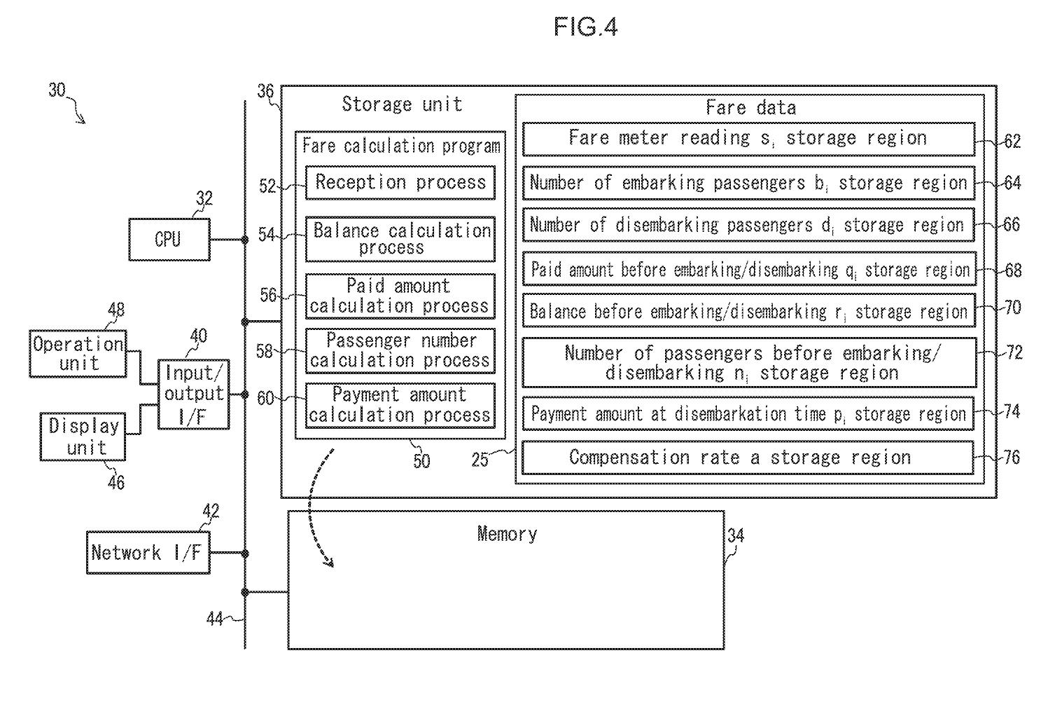

Ride-share fare calculation device 10 can be implemented, for example, by computer 30 illustrated in FIG. 4. Computer 30 has the function of calculating the payment amount at disembarkation time pᵢ based on data for fare calculation 25 by executing fare calculation program 50 illustrated in FIGS. 3 and 4, and outputting the calculation result from output unit 26.

Computer 30, as illustrated in FIG. 4, is provided with CPU (Central Processing Unit) 32, memory 34, non-volatile storage unit 36, input/output interface (I/F) 40 and network I/F 42. CPU 32, memory 34, non-volatile storage unit 36, input/output I/F 40 and network I/F 42 are connected to each other via bus 44. Input/output I/F 40 is connected to display unit 46 and operation unit 48.

Display unit 46 performs display related to the ride-share fare and the calculation thereof. Specific examples of display unit 46 of the present embodiment include touch panels and liquid crystal displays. Input/output I/F 40 and display unit 46 correspond to input unit 12 discussed above.

Operation unit 48 is operated by users of ride-share fare calculation device 10 with respect to input of data for fare calculation 25 and the like. Specific examples of operation unit 48 include touch panels, microphones and keyboards. Input/output I/F 40 and operation unit 48 correspond to output unit 26 discussed above.

Display unit 46 and operation unit 48 may be an integrated touch panel.

Storage unit 36 is implemented by an HDD (Hard Disk Drive), a flash memory, or the like. Storage unit 36, as a storage medium, stores fare calculation program 50, which causes computer 30 to function as ride-share fare calculation device 10.

CPU 32 reads outs fare calculation program 50 from storage unit 36, opens the program in memory 34, and sequentially executes the respective processes included in fare calculation program 50.

Fare calculation program 50, which is one example of a ride-share fare calculation program according to the disclosed technique, includes reception process 52, balance calculation process 54, paid amount calculation process 56, passenger number calculation process 58, and payment amount calculation process 60.

CPU 32 operates reception unit 14 by executing reception process 52. Further, CPU 32 operates balance calculation unit 16 by executing balance calculation process 54. Further, CPU 32 operates paid amount calculation unit 18 by executing paid amount calculation process 56. Further, CPU 32 operates passenger number calculation unit 20 by executing passenger number calculation process 58. In addition, CPU 32 operates payment amount calculation unit 22 by executing payment amount calculation process 60.

As a result, computer 30, which has executed fare calculation program 50, functions as ride-share fare calculation device 10. Fare calculation program 50 is one example of a ride-share fare calculation program according to the disclosed technique.

Further, data for fare calculation 25 is stored at storage unit 36. Fare meter reading sᵢ storage region 62 functions as a storage region at which fare meter reading sᵢ is stored. Number of embarking passengers bᵢ storage region 64 functions as a storage region at which number of embarking passengers bᵢ is stored. Number of disembarking passengers dᵢ storage region 66 functions as a storage region at which number of disembarking passengers dᵢ is stored. Paid amount before embarking/disembarking qᵢ storage region 68 functions as a storage region at which paid amount before embarking/disembarking qᵢ is stored. Balance before embarking/disembarking rᵢ storage region 70 functions as a storage region at which balance before embarking/disembarking rᵢ is stored. Number of passengers before embarking/disembarking nᵢ storage region 72 functions as a storage region at which number of passengers before embarking/disembarking nᵢ is stored. Payment amount at disembarkation time pᵢ storage region 74 functions as a storage region at which payment amount at disembarkation time pᵢ is stored. Compensation rate a storage region 76 functions as a storage region at which compensation rate a is stored.

Explanation is provided regarding the case of computer 30 in which, as a specific example, ride-share fare calculation device 10 of the present embodiment is a PDA (Personal Digital Assistant; portable information terminal device) such as a smartphone or a tablet terminal. Computer 30 is not limited to a PDA. Computer 30 may be, for example, a lap-top type personal computer.

Ride-share fare calculation device 10 can be implemented, for example, with a semiconductor integrated circuit; more specifically, an ASIC (Application Specific Integrated Circuit) or the like.

Next, the mechanism of ride-share fare calculation device 10 according to the present embodiment is explained.

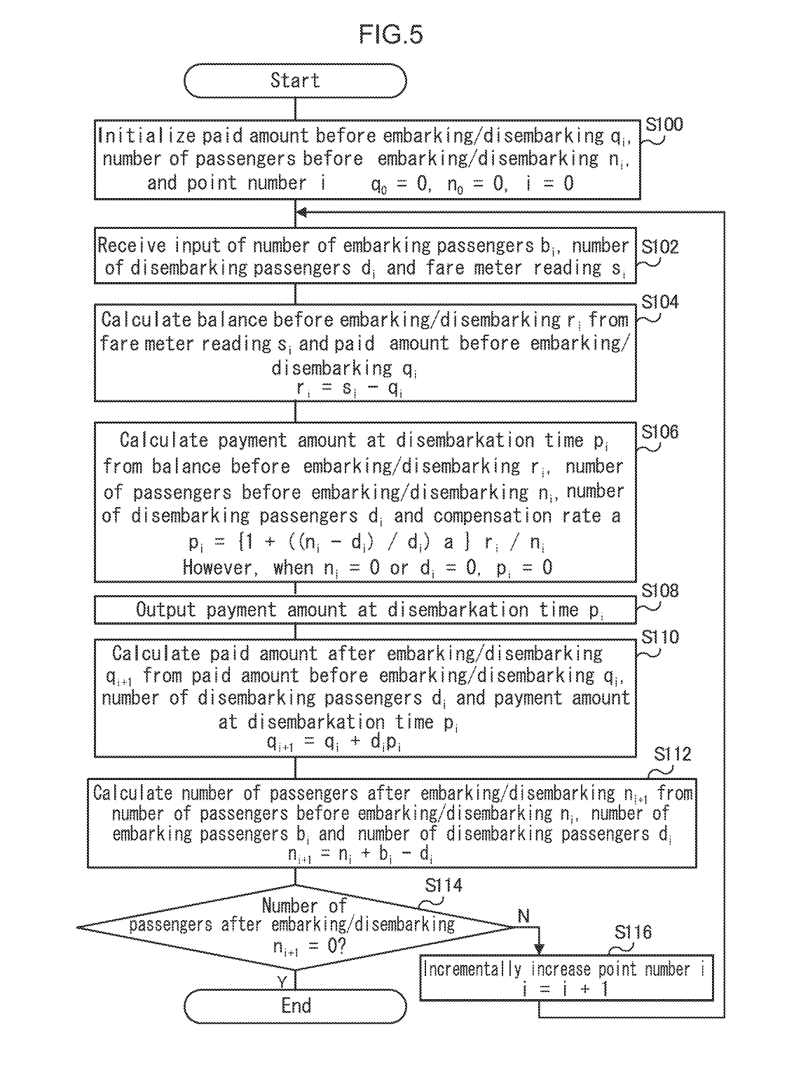

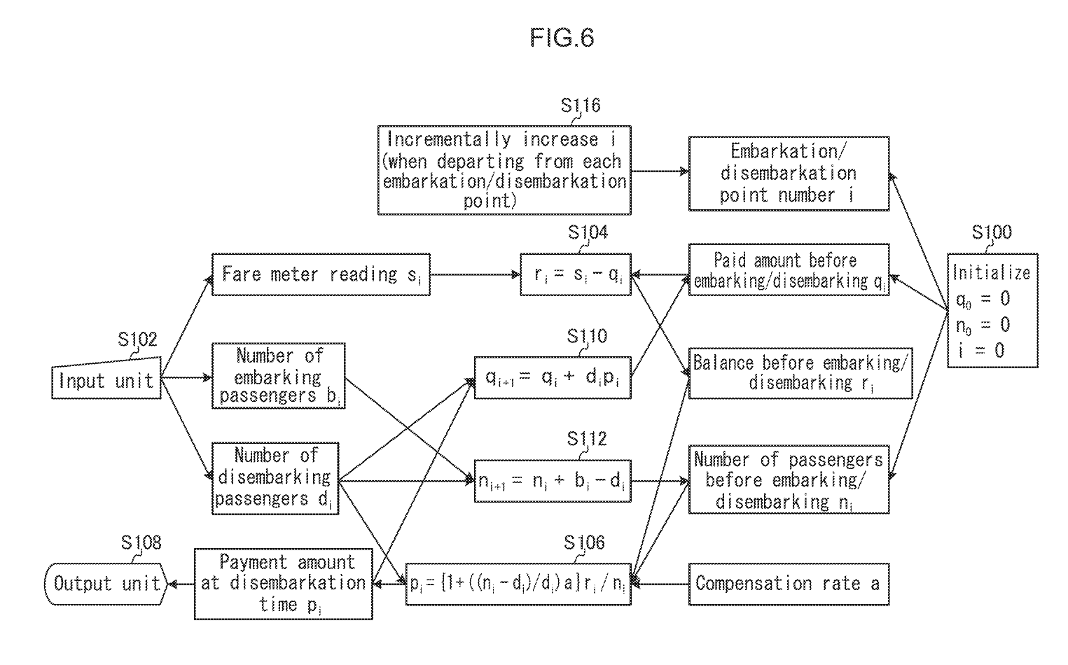

The ride-share fare calculation processing performed at ride-share fare calculation device 10 is explained. FIG. 5 is a flowchart illustrating one example of ride-share fare calculation processing performed by ride-share fare calculation device 10 according to the present embodiment. Further, FIG. 6 is an explanatory view for explaining ride-share fare calculation processing at point i.

The ride-share fare calculation processing illustrated in FIGS. 5 and 6 is one example of processing that calculates the payment amount for each user for one ride-share usage of a taxi. That is, the ride-share fare calculation illustrated in FIGS. 5 and 6 is one example of processing that calculates the payment amount for each user at each disembarkation point, from when the first user embarks and ride-share fare calculation is initiated, until the last user disembarks and ride-share fare calculation is completed.

The ride-share fare calculation processing is executed by ride-share fare calculation device 10 by, for example, a user, among plural users, who rides from the beginning of the ride share until the final disembarkation point. As a specific example, execution of the ride-share fare calculation processing is initiated by the user starting up a smartphone application or the like. When not proscribed by legislation or the like, the ride-share fare calculation processing may be executed by ride-share fare calculation device 10 by the taxi driver, for example.

First, in step S100, ride-share fare calculation device 10 initializes paid amount before embarking/disembarking qᵢ, number of passengers before embarking/disembarking and point number i. Specifically, reception unit 14 initializes point number i such that i=0. Further, paid amount calculation unit 18 initializes paid amount before embarking/disembarking qᵢ such that q₀=0. In addition, passenger number calculation unit 20 initializes number of passengers before embarking/disembarking nᵢ such that n₀=0.

In next step S102, reception unit 14 receives number of embarking passengers bᵢ, number of disembarking passengers dᵢ and fare meter reading which have been input by a user via input unit 12. Specifically, first, reception unit 14 displays, at display unit 46, a display that prompts a user to input number of embarking passengers bᵢ, number of disembarking passengers dᵢ and fare meter reading sᵢ. On arrival at point i, the user, in accordance with the display, inputs number of embarking passengers bᵢ, number of disembarking passengers dᵢ and fare meter reading sᵢ via input unit 12 of ride-share fare calculation device 10. Reception unit 14 receives the number of embarking passengers bᵢ, number of disembarking passengers dᵢ and fare meter reading sᵢ input by the user. The number of embarking passengers bᵢ, number of disembarking passengers dᵢ and fare meter reading sᵢ received by reception unit 14 are temporarily stored at fare calculation data storage unit 24.

In next step S104, balance calculation unit 16 calculates balance before embarking/disembarking rᵢ from fare meter reading sᵢ and paid amount before embarking/disembarking qᵢ. Specifically, balance calculation unit 16 reads out fare meter reading sᵢ and paid amount before embarking/disembarking qᵢ from fare calculation data storage unit 24 and calculates balance before embarking/disembarking rᵢ using Equation (1). The balance before embarking/disembarking rᵢ calculated by balance calculation unit 16 is temporarily stored at fare calculation data storage unit 24.

rᵢ=sᵢ−qᵢ Equation (1)

In next step S106, payment amount calculation unit 22 calculates payment amount at disembarkation time pᵢ from balance before embarking/disembarking rᵢ, number of passengers before embarking/disembarking number of disembarking passengers dᵢ and compensation rate a. Specifically, payment amount calculation unit 22 reads out balance before embarking/disembarking rᵢ, number of passengers before embarking/disembarking nᵢ, number of disembarking passengers dᵢ and compensation rate a from fare calculation data storage unit 24 and calculates payment amount at disembarkation time pᵢ using Equation (2). The payment amount at disembarkation time pᵢ calculated by payment amount calculation unit 22 is temporarily stored at fare calculation data storage unit 24.

$$\begin{matrix} Equation ( 2 ) & \\ calculates a total amount of money , which is the compensation \\ {p}_{i} = \{ 1 + ( \frac{{n}_{i} - {d}_{i}}{{d}_{i}} ) a \} \frac{{r}_{i}}{{n}_{i}} & Equation ( 2 )\end{matrix}$$

amount, as calculated by ((nᵢ−dᵢ)/dᵢ)×a×(rᵢ/nᵢ), added to an equal split amount (an amount of money in a case in which the payment amount for plural users is made is fixed), as calculated by rᵢ/nᵢ, as payment amount at disembarkation time pᵢ.

Here compensation rate a is a value of 0<a<1 as discussed above. By Equation (2), when compensation rate a=0, payment amount at disembarkation time pᵢ=balance before embarking/disembarking rᵢ/number of passengers before embarking/disembarking nᵢ. Further, by Equation (2), when compensation rate a=1, payment amount at disembarkation time pᵢ=balance before embarking/disembarking rᵢ/number of disembarking passengers dᵢ. That is, compensation rate a in the present embodiment is determined in advance such that rᵢ/nᵢ<pᵢ<rᵢ/dᵢ. This means that payment amount at disembarkation time pᵢ ranges from an amount of money that is the balance before embarking/disembarking rᵢ divided equally between users that have ridden as far as point i, to an amount of money that is the balance before embarking/disembarking rᵢ divided equally between users disembarking at point i.

When number of passengers before embarking/disembarking nᵢ=0, this indicates a case in which the number of passengers immediately before point i is “0”—that is, a case in which point i is the ride-share starting point. Since there are no disembarking users at the ride-share starting point, payment amount at disembarkation time pᵢ=0. Further, when number of disembarking passengers dᵢ=0, this indicates a case in which only riding users are present at point i, and since there are no disembarking users, there is no need for payment and payment amount at disembarkation time pᵢ=0. Therefore, in Equation (2), payment amount at disembarkation time pᵢ=0 when at least one of number of disembarking passengers dᵢ=0 or number of passengers before embarking/disembarking nᵢ=0 is satisfied.

In next step S108, output unit 26 outputs the payment amount at disembarkation time pᵢ calculated by payment amount calculation unit 22. Users disembarking at point i pay the output payment amount at disembarkation time pᵢ as the taxi ride-share fare.

In next step S110, paid amount calculation unit 18 calculates paid amount after embarking/disembarking qᵢ₊₁ from paid amount before embarking/disembarking qᵢ and payment amount at disembarkation time pᵢ. Paid amount after embarking/disembarking qᵢ₊₁ is the amount that has been paid after users embark or disembark at point i and corresponds to the paid amount before embarking or disembarking at point i+1.

Specifically, paid amount calculation unit 18 reads out paid amount before embarking/disembarking qᵢ, number of disembarking passengers dᵢ and payment amount at disembarkation time pᵢ from fare calculation data storage unit 24 and calculates paid amount after embarking/disembarking qᵢ₊₁ using Equation (3). The paid amount after embarking/disembarking qᵢ₊₁ calculated by paid amount calculation unit 18 is temporarily stored at fare calculation data storage unit 24.

qᵢ₊₁=qᵢ+dᵢpᵢ Equation (3)

In next step S112, passenger number calculation unit 20 calculates number of passengers after embarking/disembarking nᵢ₊₁ from number of passengers before embarking/disembarking nᵢ, number of embarking passengers bᵢ and number of disembarking passengers dᵢ. Number of passengers after embarking/disembarking nᵢ₊₁ is the number of users riding the taxi after users embark or disembark at point i and corresponds to the number of passengers before embarking or disembarking at point i+1.

Specifically, passenger number calculation unit 20 reads out number of passengers before embarking/disembarking nᵢ, number of embarking passengers bᵢ, and number of disembarking passengers dᵢ from fare calculation data storage unit 24 and calculates number of passengers after embarking/disembarking nᵢ₊₁ using Equation (4). The number of passengers after embarking/disembarking nᵢ₊₁ calculated by passenger number calculation unit 20 is temporarily stored at fare calculation data storage unit 24.

nᵢ₊₁=nᵢ+bᵢ−dᵢ Equation (4)

In next step S114, reception unit 14 determines whether or not number of passengers after embarking/disembarking nᵢ₊₁=0. When number of passengers after embarking/disembarking nᵢ₊₁=0, this indicates a state in which all users have disembarked from the taxi and there are no passengers. As a result, when number of passengers after embarking/disembarking nᵢ₊₁=0, the present processing is terminated. However, when number of passengers after embarking/disembarking nᵢ₊₁≠0, since there are still users riding the taxi as passengers, the present processing is not terminated and proceeds to step S116.

In step S116, reception unit 14 incrementally increases point number i, returns to step S102, and repeats the present processing. Specifically, reception unit 14 makes i=i+1 and repeats the processing of steps S102 to S114 until all users have disembarked.

Specific examples of ride-share fare calculation processing being performed by the ride-share fare calculation device of the present embodiment are explained below. In the following examples, explanation is provided of cases in which compensation rate a=0.15, as a specific example.

### Example 1

As Example 1, a case is explained in which plural users, including users with the same embarkation point and different disembarkation points, are ride-sharing a taxi. In Example 1, a case is explained in which five users ride-share one taxi, as a specific example.

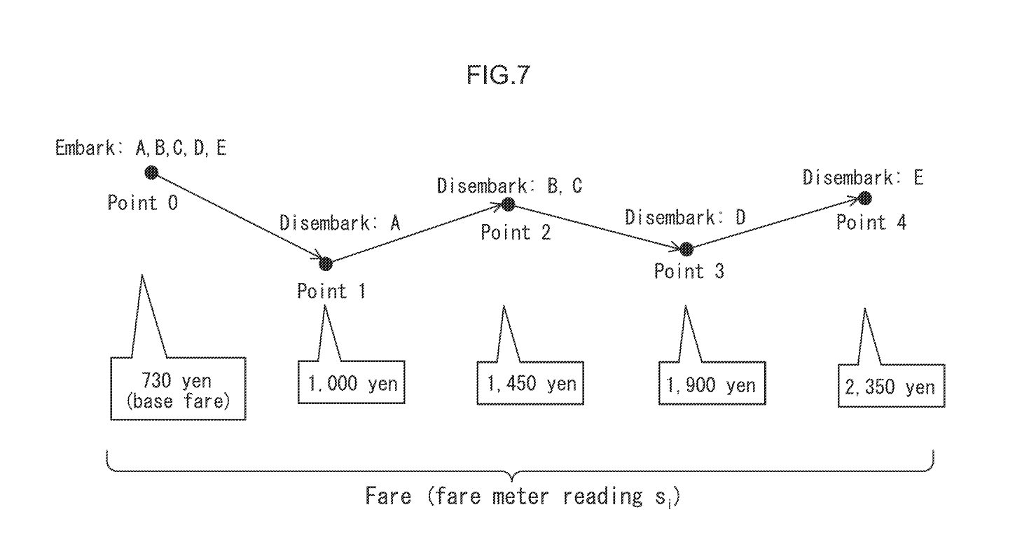

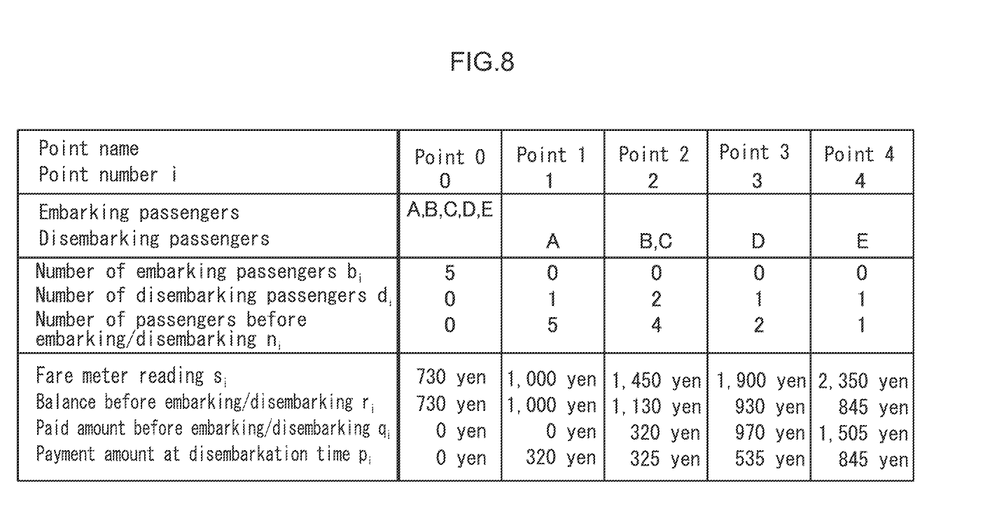

FIG. 7 is an explanatory view for explaining a specific example of the respective embarkation and disembarkation points of five users, and the fare meter reading sᵢ at the disembarkation points, in Example 1. Further, FIG. 8 is an explanatory view for explaining payment amount at the time of disembarkation pᵢ, which is the ride-share fare for each user, in Example 1.

As illustrated in FIG. 7, first, five users (users A to E) get into the taxi at point 0 (point number i=0), and engage in ride-sharing. In the present example, in order to calculate the ride-share fare, the user that will disembark last among the five users (as a specific example, user E), executes ride-share fare calculation processing at ride-share fare calculation device 10. As a specific example, user E initiates the ride-share fare calculation processing by starting up a smartphone application or the like.

When the ride-share fare calculation processing is initiated, first, in step S100, paid amount before embarking/disembarking qᵢ, number of passengers before embarking/disembarking nᵢ, and point number i are initialized.

First, at point 0, the user, since the base fare of the taxi is 730 yen, inputs number of embarking passengers b₀=5, number of disembarking passengers d₀=0, and fare meter reading s₀=730. Reception unit 14 receives number of embarking passengers b₀=5, number of disembarking passengers d₀=0, and fare meter reading s₀=730 (S102).

Balance calculation unit 16, using Equation (1), calculates r₀=730−0=730 (S104). Payment amount calculation unit 22, using Equation (2), calculates p₀={1+((0−0)/0)×0.15}×730/0; however, since number of disembarking passengers d₀=0, payment amount at disembarkation time p₀=0 (S106). When output unit 26 outputs payment amount at disembarkation time p₀=0 (S108), 0 yen is displayed as payment amount at disembarkation time p₀ on the screen of the user's smartphone, for example.

In preparation for the next calculation, paid amount calculation unit 18, using Equation (3), calculates q₁=0+0×0=0 (S110). Further, passenger number calculation unit 20, using Equation (4), calculates n₁=0+5−0=5 (S112).

Since n₁≠0 (negative determination at S114) and users A to E are riding the taxi as passengers, i=0+1=1 (S116).

At point 1, which is the next disembarkation point, user A disembarks from the taxi, and no users get into the taxi at point 1.

Since the fare meter indicates 1000 yen, the user inputs number of embarking passengers bᵢ=0, number of disembarking passengers d₁=1, and fare meter reading s₁=1000. Reception unit 14 receives number of embarking passengers b₁=0, number of disembarking passengers d₁=1, and fare meter reading s₁=1000 (S102).

Balance calculation unit 16, using Equation (1), calculates r₁=1000−0=1000 (S104). Payment amount calculation unit 22, using Equation (2), calculates p₁={1+((5−1)/1)×0.15}×1000/5=320 (S106). When output unit 26 outputs payment amount at disembarkation time p₁=320 (S108), 320 yen is displayed as payment amount at disembarkation time p₁ on the screen of the user's smartphone, for example. In accordance with this display, user A pays 320 yen as the ride-share fare.

In preparation for the next calculation, paid amount calculation unit 18, using Equation (3), calculates q₂=0+1×320=320 (S110). Further, passenger number calculation unit 20, using Equation (4), calculates n₂=5+0−1=4 (S112).

Since n₂≠0 (negative determination at S114) and users B to E are riding the taxi as passengers, i=1+1=2 (S116).

At point 2, which is the next disembarkation point, users B and C disembark from the taxi, and no users get into the taxi at point 2.

Since the fare meter indicates 1450 yen, the user inputs number of embarking passengers b₂=0, number of disembarking passengers d₂=2, and fare meter reading s₂=1450. Reception unit 14 receives number of embarking passengers b₂=0, number of disembarking passengers d₂=2, and fare meter reading s₂=1450 (S102).

Balance calculation unit 16, using Equation (1), calculates r₂=1450−320=1130 (S104). Payment amount calculation unit 22, using Equation (2), calculates p₂={1+((4−2)/2)×0.15}×1130/4≈325 (S106). At balance calculation unit 16 of the present embodiment, as a specific example, when the calculation result of Equation (2) has a decimal fraction, the payment amount at disembarkation time pᵢ is rounded off at the first decimal place. When output unit 26 outputs payment amount at disembarkation time p₂=325 (S108), 325 yen is displayed as payment amount at disembarkation time p₂ on the screen of the user's smartphone, for example. In accordance with this display, users B and C each pay 325 yen as the ride-share fare.

In preparation for the next calculation, paid amount calculation unit 18, using Equation (3), calculates q₃=320+2×325=970 (S110). Further, passenger number calculation unit 20, using Equation (4), calculates n₃=4+0−2=2 (S112).

Since n₃≠0 (negative determination at S114) and users D and E are riding the taxi as passengers, i=2+1=3 (S116).

At point 3, which is the next disembarkation point, user D disembarks from the taxi, and no users get into the taxi at point 3.

Since the fare meter indicates 1900 yen, the user inputs number of embarking passengers b₃=0, number of disembarking passengers d₃=1, and fare meter reading s₃=1900. Reception unit 14 receives number of embarking passengers b₃=0, number of disembarking passengers d₃=1, and fare meter reading s₃=1900 (S102).

Balance calculation unit 16, using Equation (1), calculates r₃=1900−970=930 (S104). Payment amount calculation unit 22, using Equation (2), calculates p₃={1+((2−1)/1)×0.15}×930/2≈535 (S106). When output unit 26 outputs payment amount at disembarkation time p₃=535 (S108), 535 yen is displayed as payment amount at disembarkation time p₃ on the screen of the user's smartphone, for example. In accordance with this display, user D pays 535 yen as the ride-share fare.

In preparation for the next calculation, paid amount calculation unit 18, using Equation (3), calculates q₄=970+1×535=1505 (S110). Further, passenger number calculation unit 20, using Equation (4), calculates n₄=2+0−1=1 (S112).

Since n₄≈0 (negative determination at S114) and user E is riding the taxi as a passenger, i=3+1=4 (S116).

At point 4, which is the next disembarkation point and the final disembarkation point, user E disembarks from the taxi.

Since the fare meter indicates 2350 yen, the user inputs number of embarking passengers b₄=0, number of disembarking passengers d₄=1, and fare meter reading s₄=2350. Reception unit 14 receives number of embarking passengers b₄=0, number of disembarking passengers d₄=1, and fare meter reading s₄=2350 (S102).

Balance calculation unit 16, using Equation (1), calculates r₄=2350−1505=845 (S104). Payment amount calculation unit 22, using Equation (2), calculates p₄={1+((1−1)/1)×0.15}×845/1=845 (S106). When output unit 26 outputs payment amount at disembarkation time p₃=845 (S108), 845 yen is displayed as payment amount at disembarkation time p₄ on the screen of the user's smartphone, for example. In accordance with this display, user E pays 845 yen as the ride-share fare.

In preparation for the next calculation, paid amount calculation unit 18, using Equation (3), calculates q₅=1505+1×845=2350 (S110). Further, passenger number calculation unit 20, using Equation (4), calculates n₅=1+0−1=0 (S112).

Since n₅=0 (positive determination at S114), the present processing is terminated.

Since user E becomes the only taxi passenger after user D's ride-share fare (payment amount at disembarkation time p₃) is established at point 3, user E may terminate the ride-share fare calculation processing at this time. As a specific example, user E may terminate the ride-share fare calculation processing by terminating (including forced termination) the execution of a smartphone application or the like.

In this way, in the present example, since user A pays 320 yen as the ride-share fare when user A would have had to pay 1000 yen if using the taxi alone, the payment amount is cheaper than in the case of single use. Further, since users B and C pay 325 yen as the ride-share fare when they would have had to pay 1450 yen each if using the taxi alone, the payment amount is cheaper than in the case of single use. Further, since user D pays 535 yen as the ride-share fare when user D would have had to pay 1900 yen if using the taxi alone, the payment amount is cheaper than in the case of single use. Further, since user E pays 845 yen as the ride-share fare when user E would have had to pay 2350 yen if using the taxi alone, the payment amount is cheaper than in the case of single use.

Each of users A to E pays a lower amount than if they had paid singly, and can pay an amount that includes compensation for users who disembark subsequently. In this way, according to ride-share fare calculation device 10, since disadvantages to a subsequent user to disembark, due, for example, to detours via the disembarkation point of a previous user to disembark, are compensated for, unfairness in payment amounts is rectified and fairness can be achieved.

### Example 2

As Example 2, a case is explained in which plural users, including users with different disembarkation points and different embarkation points, are ride-sharing a taxi. In Example 2, a case is explained in which five users ride-share one taxi, as a specific example.

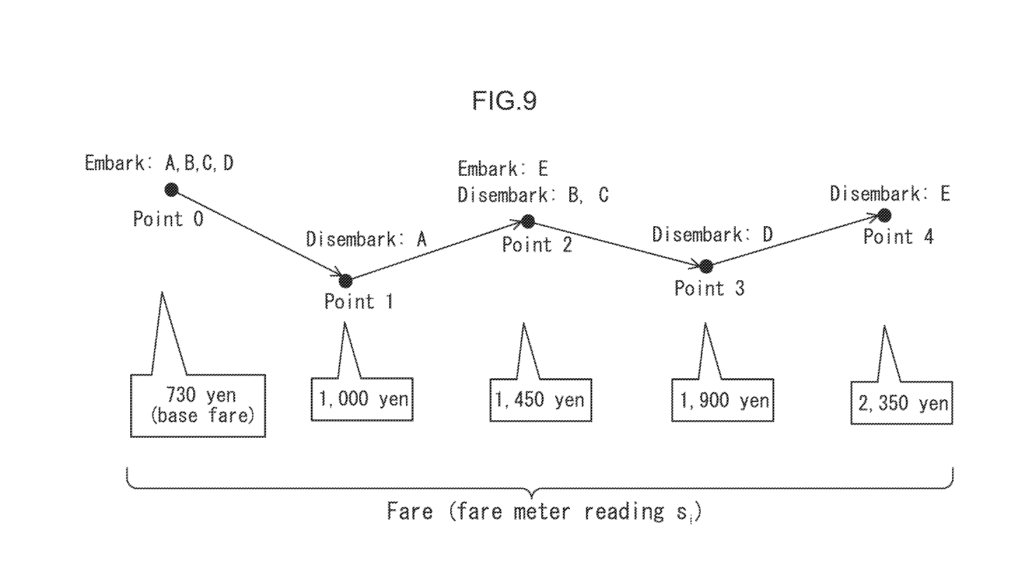

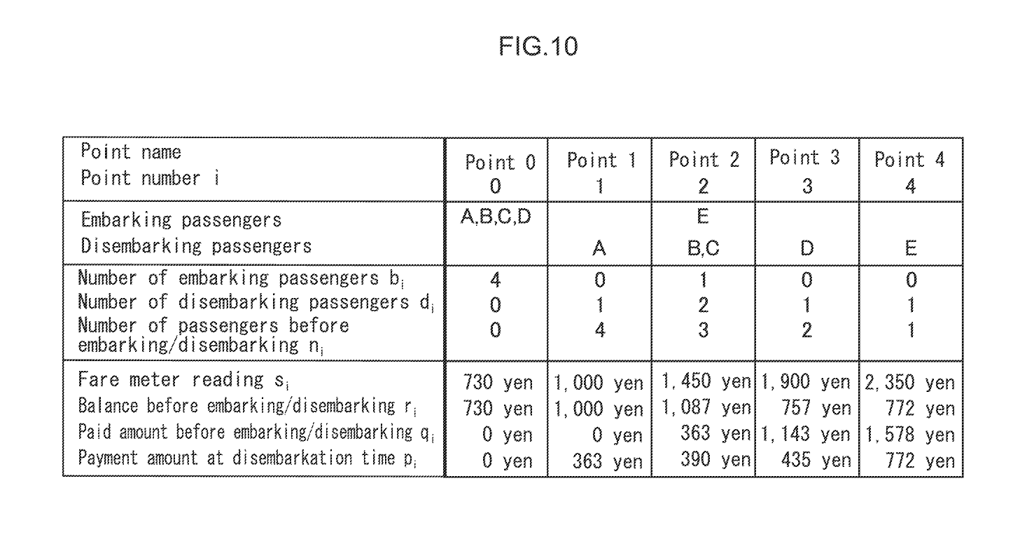

FIG. 9 is an explanatory view for explaining a specific example of the respective embarkation and disembarkation points of five users, and the fare meter reading sᵢ at the disembarkation points, in Example 2. Further, FIG. 10 is an explanatory view for explaining payment amount at the time of disembarkation pᵢ, which is the ride-share fare for each user, in Example 2.

As illustrated in FIG. 9, first, four users (users A to D) get into the taxi at point 0 (point number i=0), and engage in ride-sharing. In order to calculate the ride-share fare, any of the users executes ride-share fare calculation processing at ride-share fare calculation device 10. In the present example, none of the users rides the taxi from the beginning to the end of the ride-share. In such a case, the ride-share fare may be calculated by a ride-share fare calculation device 10 that is provided on a network, for example, and the calculation results may be displayed on the smartphone or the like of each user.

When the ride-share fare calculation processing is initiated, first, in step S100, paid amount before embarking/disembarking qᵢ, number of passengers before embarking/disembarking nᵢ, and point number i are initialized.

First, at point 0, the user, since the base fare of the taxi is 730 yen, inputs number of embarking passengers b₀=4, number of disembarking passengers d₀=0, and fare meter reading s₀=730. Reception unit 14 receives number of embarking passengers b₀=4, number of disembarking passengers d₀=0, and fare meter reading s₀=730 (S102).

Balance calculation unit 16, using Equation (1), calculates r₀=730−0=730 (S104). Payment amount calculation unit 22, using Equation (2), calculates p₀={1+((0−0)/0)×0.15}×730/0; however, since number of disembarking passengers d₀=0, payment amount at disembarkation time p₀=0 (S106). When output unit 26 outputs payment amount at disembarkation time p₀=0 (S108), 0 yen is displayed as payment amount at disembarkation time p₀ on the screen of the users' smartphones, for example.

In preparation for the next calculation, paid amount calculation unit 18, using Equation (3), calculates q₁=0+0×0=0 (S110). Further, passenger number calculation unit 20, using Equation (4), calculates n₁=0+4−0=4 (S112).

Since n₁≈0 (negative determination at S114) and users A to D are riding the taxi as passengers, i=0+1=1 (S116).

At point 1, which is the next disembarkation point, user A disembarks from the taxi, and no users get into the taxi at point 1.

Since the fare meter indicates 1000 yen, the user inputs number of embarking passengers b₁=0, number of disembarking passengers d₁=1, and fare meter reading s₁=1000. Reception unit 14 receives number of embarking passengers b₁=0, number of disembarking passengers d₁=1, and fare meter reading s₁=1000 (S102).

Balance calculation unit 16, using Equation (1), calculates r₁=1000−0=1000 (S104). Payment amount calculation unit 22, using Equation (2), calculates p₁={1+((4−1)/1)×0.15}1000/4≈363 (S106). At balance calculation unit 16 of the present embodiment, as a specific example, when the calculation result of Equation (2) has a decimal fraction, the payment amount at disembarkation time pᵢ is rounded off at the first decimal place. When output unit 26 outputs payment amount at disembarkation time p₁=363 (S108), 363 yen is displayed as payment amount at disembarkation time p₁ on the screen of the users' smartphones, for example. In accordance with this display, user A pays 363 yen as the ride-share fare.

In preparation for the next calculation, paid amount calculation unit 18, using Equation (3), calculates q₂=0+1×363=363 (S110). Further, passenger number calculation unit 20, using Equation (4), calculates n₂=4+0−1=3 (S112).

Since n₂≈0 (negative determination at S114) and users B to D are riding the taxi as passengers, i=1+1=2 (S116).

At point 2, which is the next disembarkation point, users B and C disembark from the taxi, and user E gets into the taxi

Since the fare meter indicates 1450 yen, the user inputs number of embarking passengers b₂=1, number of disembarking passengers d₂=2, and fare meter reading s₂=1450. Reception unit 14 receives number of embarking passengers b₂=1, number of disembarking passengers d₂=2, and fare meter reading s₂=1450 (S102).

Balance calculation unit 16, using Equation (1), calculates r₂=1450−363=1087 (S104). Payment amount calculation unit 22, using Equation (2), calculates p₂={1+((3−2)/2)×0.15}×1087/3≈390 (S106). When output unit 26 outputs payment amount at disembarkation time p₂=390 (S108), 390 yen is displayed as payment amount at disembarkation time p₂ on the screen of the users' smartphones, for example. In accordance with this display, users B and C each pay 390 yen as the ride-share fare.

In preparation for the next calculation, paid amount calculation unit 18, using Equation (3), calculates q₃=363+2×390=1143 (S110). Further, passenger number calculation unit 20, using Equation (4), calculates n₃=3+1−2=2 (S112).

Since n₃≠0 (negative determination at S114) and users D and E are riding the taxi as passengers, i=2+1=3 (S116).

At point 3, which is the next disembarkation point, user D disembarks from the taxi, and no users get into the taxi at point 3.

Since the fare meter indicates 1900 yen, the user inputs number of embarking passengers b₃=0, number of disembarking passengers d₃=1, and fare meter reading s₃=1900. Reception unit 14 receives number of embarking passengers b₃=0, number of disembarking passengers d₃=1, and fare meter reading s₃=1900 (S102).

Balance calculation unit 16, using Equation (1), calculates r₃=1900−1143=757 (S104). Payment amount calculation unit 22, using Equation (2), calculates p₃={1+((2−1)/1)×0.15}×757/2≈435 (S106). When output unit 26 outputs payment amount at disembarkation time p₃=435 (S108), 435 yen is displayed as payment amount at disembarkation time p₃ on the screen of the users' smartphones, for example. In accordance with this display, user D pays 435 yen as the ride-share fare.

In preparation for the next calculation, paid amount calculation unit 18, using Equation (3), calculates q₄=1143+1×435=1578 (S110). Further, passenger number calculation unit 20, using Equation (4), calculates n₄=2+0−1=1 (S112).

Since n₄≠0 (negative determination at S114) and user E is riding the taxi as a passenger, i=3+1=4 (S116).

At point 4, which is the next disembarkation point and the final disembarkation point, user E disembarks from the taxi.

Since the fare meter indicates 2350 yen, the user inputs number of embarking passengers b₄=0, number of disembarking passengers d₄=1, and fare meter reading s₄=2350. Reception unit 14 receives number of embarking passengers b₄=0, number of disembarking passengers d₄=1, and fare meter reading s₄=2350 (S102).

Balance calculation unit 16, using Equation (1), calculates r₄=2350−1578=772 (S104). Payment amount calculation unit 22, using Equation (2), calculates p₄={1+((1−1)/1)×0.15}×772/1=772 (S106). When output unit 26 outputs payment amount at disembarkation time p₃=772 (S108), 772 yen is displayed as payment amount at disembarkation time p₄ on the screen of the user's smartphone, for example. In accordance with this display, user E pays 772 yen as the ride-share fare.

In preparation for the next calculation, paid amount calculation unit 18, using Equation (3), calculates q₅=1578+1×772=2350 (S110). Further, passenger number calculation unit 20, using Equation (4), calculates n₅=1+0−1=0 (S112).

Since n₅=0 (positive determination at S114), the present processing is terminated.

Since user E becomes the only taxi passenger after user D's ride-share fare (payment amount at disembarkation time p₃) is established at point 3, user E may terminate the ride-share fare calculation processing at this time. As a specific example, user E may terminate the ride-share fare calculation processing by terminating (including forced termination) the execution of a smartphone application or the like.

In this way, in the present example, since user A pays 363 yen as the ride-share fare when user A would have had to pay 1000 yen if using the taxi alone, the payment amount is cheaper than in the case of single use. Further, since users B and C pay 390 yen as the ride-share fare when they would have had to pay 1450 yen each if using the taxi alone, the payment amount is cheaper than in the case of single use. Further, since user D pays 435 yen as the ride-share fare when user D would have had to pay 1900 yen if using the taxi alone, the payment amount is cheaper than in the case of single use. Further, since user E pays 772 yen as the ride-share fare when user E would have had to pay 2350−1450=900 yen (disregarding the base fare) if using the taxi alone, the payment amount is cheaper than in the case of single use.

Each of users A to E pays a lower amount than if they had paid singly, and can pay an amount that includes compensation for users who disembark subsequently. In this way, according to ride-share fare calculation device 10, since disadvantages to a subsequent user to disembark, due, for example, to detours via the disembarkation point of a previous user to disembark, are compensated for, unfairness in payment amounts is rectified and fairness can be achieved.

Since there is a lower number of users performing ride-sharing than in Example 1 up to point 2, the payment amounts for users disembarking at point 1 and point 2, respectively, is higher in Example 2 than in Example 1. However, for user E, who embarks at point 2 and disembarks at point 4, the payment amount when disembarking is lower than in Example 1 since the length of the ride is shorter than for user E in Example 1.

The amount of increase in fare meter reading sᵢ from point 2 at which user E embarks to point 4 is 900 yen. As a result, the payment amount of 772 yen might seem rather expensive at first glance; however, this payment amount is within an appropriate range in terms of fairness in view of the facts that the base fare is not taken into account and the length of the ride is long.

As explained above, in ride-share fare calculation device 10 of the present embodiment, payment amount calculation unit 22, using Equation (2), calculates payment amount at disembarkation time pᵢ based on number of passengers before embarking/disembarking nᵢ, number of disembarking passengers dᵢ, compensation rate a, and balance before embarking/disembarking rᵢ. In this way, in ride-share fare calculation device 10 of the present embodiment, payment amount at disembarkation time pᵢ is calculated without using information related to the disembarkation points of subsequently disembarking users. As a result, by using ride-share fare calculation device 10, payment amount at disembarkation time pᵢ can be calculated irrespective of the disembarkation points of subsequently disembarking users.

Further, in ride-share fare calculation device 10, the compensation amount is calculated by compensation rate a where 0<a<1. As a result, by using ride-share fare calculation device 10, payment amount at disembarkation time pᵢ can be calculated by adding an amount of money that compensates for disadvantages in terms of time or money experienced by a subsequent user to disembark, due, for example, to detours for a previous user to disembark.

Accordingly, by using ride-share fare calculation device 10 of the present embodiment, the payment amount of a previous user to disembark can be calculated by adding an amount of money that compensates for disadvantages to a subsequent user to disembark, irrespective of the disembarkation point of the subsequent user to disembark. As a result, by using ride-share fare calculation device 10, since disadvantages experienced by the subsequent user to disembark, due, for example, to detours via the disembarkation point of the previous user to disembark, are compensated for, unfairness in the payment amount can be rectified and fairness can be achieved.

In the present embodiment, a case has been explained in which a user inputs number of embarking passengers bᵢ, number of disembarking passengers dᵢ, and fare meter reading sᵢ; however, the method of input is not limited to the present embodiment. The input method may be, for example, electronically coordinated with the taxi fare meter or the like via network I/F 42, and input performed automatically.

Ride-share fare calculation device 10 of the present embodiment (ride-share fare calculation processing and fare calculation program 50) may be used in combination with other ride-share support services (for example, different kinds of device, processing and program).

As other ride-share support services, services are known, for example, that discover partners suitable for ride-sharing by searching based on registered information and current status information related to ride-share candidates and that provide notification of ride-share candidates. Ride-share fare calculation device 10 of the present embodiment may be combined with such services so as to determine whether another party is suitable for ride-share. When combining in this way, first, for example, a taxi travel route is estimated based on information on the respective preferred embarkation points and disembarkation points of plural users that are ride-share candidates. The preferred embarkation points and disembarkation points may, for example, be input by users to terminal devices such as smartphones held by the users. Further, the preferred embarkation point may be viewed as the position of a user's terminal device based on position information, the position information on the terminal device having been determined using a Global Positioning System (GPS) receiver or the like and being received from the user's terminal device. Further, the method of estimating the travel route may be, for example, to acquire map information or the like and estimate the route based on the acquired map information. Ride-share fare calculation device 10 calculates the payment amount for each user at each disembarkation point (payment amount at disembarkation time pᵢ) based on the premise that the estimated route has been traveled. Then, in a case in which the calculated payment amount at disembarkation time pᵢ is a sufficiently cheaper fare compared to a case in which the respective users were to use the taxi alone, it is determined that the other party is suitable for ride-share. Ride-share fare calculation device 10 may calculate payment amount at disembarkation time pᵢ while changing compensation rate a throughout the range of 0<compensation rate a<1 and thereby detect the most advantageous combination of users to the users in terms of the amount of money.

Further, ride-share fare calculation device 10, in a case in which the respective embarkation points and disembarkation points of plural users are known in advance, may predict the payment amount (payment amount at disembarkation time pᵢ) for each user. For example, based on the embarkation point and disembarkation point of each user, similarly to the foregoing description, the taxi travel route is estimated and the fare to each disembarkation point is calculated. In addition, ride-share fare calculation device 10 calculates payment amount at disembarkation time pᵢ for each user in accordance with the above-described ride-share fare calculation processing and presents the calculation results to the users. In this way, by prediction of payment amount at disembarkation time pᵢ, the users can determine whether or not to engage in ride-share.

Further, compensation rate a, as described above, may be configured such that it can be set by the users, may be a value that corresponds to circumstances, and does not need to be determined in advance. For example, compensation rate a may be adjusted such that the ride-share fare becomes cheaper than a case in which the respective users were to ride alone. Further, for example, payment amount at disembarkation time pᵢ may be predicted as described above, and compensation rate a may be adjusted such that all the users accept the payment amount at disembarkation time pᵢ. In such a case, while changing the compensation rate a, payment amount at disembarkation time pᵢ may be calculated for each compensation rate a and presented to the users.

In the above-described embodiments, an aspect has been explained in which fare calculation program 50 is stored (installed) in advance in storage unit 36; however, an aspect may be presented in which fare calculation program 50 is recorded on a storage medium. Examples of the storage medium include a CD-ROM (Compact Disc Read Only Memory), a DVD-ROM (Digital Versatile Disk Read Only Memory) and a USB (Universal Serial Bus) memory.

In related technology, disadvantages in terms of time or the like experienced by subsequently disembarking users due, for example, to detours for previously disembarking users, are not considered in fare sharing.

Further, in related technology, it is needed to determine the embarkation point and disembarkation point of each user in advance, and the payment amount for each user may not be able to be calculated if the disembarkation point of a subsequently disembarking user is not determined. However, there are cases in which it is difficult to determine the disembarkation point of a subsequently disembarking user because there are cases in which the disembarkation point of a subsequently disembarking user remains unclear at the time at which the previously disembarking user disembarks and cases in which the destination changes after the previously disembarking user has disembarked, for example.

According to the disclosed technique, it is possible to calculate the payment amount for a previously disembarking user by adding an amount of money that compensates for disadvantages to a subsequent user to disembark, irrespective of the disembarkation point of the subsequent user to disembark.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it might want to be understood that the various changes, substitutions, and alterations could be made hereto without departing from the spirit and scope of the invention.

What is claimed is:

1. A non-transitory recording medium storing a program that causes a computer to execute a ride-share fare calculation process, the process comprising:
when a plurality of users, including users with different disembarkation points, are using, by ride-sharing, a vehicle of a passenger transportation service that determines a fare according to at least one of usage distance or usage time, calculating a payment amount of a passenger disembarking at a disembarkation point at which a user disembarks, based on a number of disembarking passengers at the disembarkation point, a number of passengers before disembarkation at the disembarkation point, a balance of the fare to the disembarkation point minus a paid or collected payment amount, and a compensation rate for a subsequently disembarking user.

2. The non-transitory recording medium of claim 1, wherein, in the ride-share fare calculation process, the calculating of the payment amount further comprises calculating a total amount obtained by adding, to an amount that is the balance divided by the number of passengers before disembarkation, a compensation amount obtained by multiplying a ratio of a number of non-disembarking passengers with respect to the number of disembarking passengers, the number of non-disembarking passengers being obtained by subtracting the number of disembarking passengers from the number of passengers before disembarkation, with the compensation rate and with the amount that is the balance divided by the number of passengers before disembarkation.

3. The non-transitory recording medium of claim 1, wherein the users include a user with a different embarkation point.

4. A ride-share fare calculation device, comprising:
a processor; and
a memory storing instructions, which when executed by the processor perform a procedure, the procedure comprising:
when a plurality of users, including users with different disembarkation points, are using, by ride-sharing, a vehicle of a passenger transportation service that determines a fare according to at least one of usage distance or usage time, calculating a payment amount of a passenger disembarking at a disembarkation point at which a user disembarks, based on a number of disembarking passengers at the disembarkation point, a number of passengers before disembarkation at the disembarkation point, a balance of the fare to the disembarkation point minus a paid or collected payment amount, and a compensation rate for a subsequently disembarking user.

5. A ride-share fare calculation method, comprising:
by a processor, when a plurality of users, including users with different disembarkation points, are using, by ride-sharing, a vehicle of a passenger transportation service that determines a fare according to at least one of usage distance or usage time, calculating a payment amount of a passenger disembarking at a disembarkation point at which a user disembarks, based on a number of disembarking passengers at the disembarkation point, a number of passengers before disembarkation at the disembarkation point, a balance of the fare to the disembarkation point minus a paid or collected payment amount, and a compensation rate for a subsequently disembarking user.
